(19) United States
(12) Patent Application Publication
(10) Pub. No.: US 2004/0186260 A1
(43) Pub. Date: Sep. 23, 2004

(54) Process for the reaction of polyorganosiloxanes

(76) Inventors: Olaf Hohenberg, Marl (DE); Hans-Guenter Krohm, Raesfeld (DE); Thomas Neumann, Bochum (DE); Thomas Reibold, Marl (DE); Michael Urban, Essen (DE); Dietmar Wewers, Bottrop (DE)

Correspondence Address: FROMMER LAWRENCE & HAUG LLP, 745 Fifth Avenue, New York, NY, 10151, US

(21) Appl. No.: 10/804,512

(22) Filed: Mar. 19, 2004

(30) Foreign Application Priority Data
Mar. 21, 2003 (DE) 103 12 636.8

(51) Int. Cl. C08G 77/04

(52) U.S. Cl. 528/25

(57) ABSTRACT

The invention relates to a process for the reaction of polyorganosiloxanes, in which a hydrogen atom bound to the silicon is replaced by an alkoxide group, and also to substituted polyorganosiloxanes prepared by this process and their use.

### RELATED APPLICATIONS

This application claims priority to German Application Serial No. 103 12 636.8, filed Mar. 21, 2003, herein incorporated by reference.

### BACKGROUND OF THE INVENTION

1. Field of the Invention

The invention relates to a process for the reaction of polyorganosiloxanes, in which a hydrogen atom bound to the silicon is replaced by an alkoxide group, and also to substituted polyorganosiloxanes prepared by this process and their use.

2. Description of Related Art

According to the prior art, polyorganosiloxanes are prepared industrially via the chlorosiloxane route. In the chlorosiloxane route, polyorganosiloxanes which bear chlorine substituents on the silicon are reacted with alcohols to form alkoxy-substituted polyorganosiloxanes. This process necessarily leads to considerable quantities of hydrochloric acid waste, which presents ecological problems and incurs considerable costs in the separation.

V. Gevorgyan et al. describe the use of B(C₆F₅)₃ catalysts in the hydrosilylation of olefins (V. Gevorgyan, J. Org. Chem., 67 (6), 1936-1940, 2002). B(C₆F₅)₃ has also been described as catalyst for the reduction of alcohols by monomeric hydrosilanes (V. Gevorgyan, J. Org. Chem., 65, 6179-6186, 2000). Lewis-acidic trivalent boron compounds are known to have a high oxophilicity, in particular boron-halogen and boron-alkyl compounds. They coordinate with oxygen-containing Lewis bases, usually to form stable complexes. For example, boron trifluoride forms adducts with a large number of electron donors such as ethers, alcohols, ketones, amines, phosphines, arsines, thiols or selenides. Coordination with oxygen-containing Lewis bases sometimes goes so far as to lead to deoxygenation. For the purposes of the present invention, deoxygenation is reduction by extrusion of an oxygen atom, for example to form strong B—O bonds. Such a deoxygenation can, for example, bring about reductive cleavage of ethers or alcohols. In this context, Gevorgyan et al. also emphasize the deoxygenative behavior of trivalent boron compounds in the presence of silanes. Furthermore, B(C₆F₅)₃ has been used as catalyst for the silylation of alcohols by monomeric hydrosilanes, in particular for introducing protective groups (W. E. Piers, J. Org. Chem. 64, 4887-4892, 1999). These reactions are also referred to as dehydrogenative hydrosilylation. In all of them, monomeric silanes which have an Si—H bond but not Si—O bond react with alcohols to liberate molecular hydrogen and form a silyl-protected alcohol (R₃Si—O—C). In addition, Piers et al. state that the reaction products prepared in a solvent from a monomeric hydrogensilane and an alcohol require work-up by column chromatography and/or recrystallization.

WO-A-01/74938 relates to the coupling of H-siloxanes with OH-siloxanes to form higher molecular weight siloxanes and also to crosslink silicones in a catalyzed dehydrogenative condensation. A number of fluorine-containing organoboron compounds are proposed as catalysts. In this process, Si—O—Si bonds are formed with liberation of molecular hydrogen.

### OBJECTS OF THE INVENTION

It is therefore an object of the invention to provide a process for preparing substituted polyorganosiloxanes, by means of which the disadvantages of the prior art can be avoided and Si—O—C bonds can be formed between terminal and/or lateral hydrogen-polyorganosiloxanes and/or -oligosiloxanes and organooxy groups without involvement of chlorine compounds and, if appropriate, in the absence of solvents. This and other objects will become apparent from the Description of the Invention.

### DESCRIPTION OF THE INVENTION

According to the invention, this and other objects are achieved in a first embodiment by a process for reacting polyorganosiloxanes which contain —Si(H) units and have the formula (I)

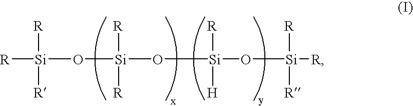

in which at least one hydrogen atom is bound to a silicon atom;

R represents one or more identical or different radicals selected from among linear or branched, saturated, monounsaturated or polyunsaturated alkyl, aryl, alkaryl and aralkyl radicals, preferably having from 1 to 20, in particular from 1 to 10, carbon atoms, haloalkyl groups having from 1 to 20 carbon atoms, siloxy groups and triorganosiloxy groups;

R′ and R″ are each, independently of one another, H or R;

x is an integer from 0 to 300 and

y is, independently of x, an integer from 0 to 100;

with at least one alcohol selected from the group consisting of linear or branched, saturated, monounsaturated or polyunsaturated, aromatic or aliphatic-aromatic monoalcohols and polyalcohols, polyether monoalcohols and polyether polyalcohols, aminoalcohols, in particular N-alkyl-, arylamino-EO-, -PO alcohols, N-alkyl or arylamino alcohols and mixtures thereof, wherein hydrogen atoms present in the Si(H)(R)—O units of the polyorganosiloxane are partly or completely replaced by alkoxide groups derived from the respective alcohols in a process step using one or more compounds of elements of main group III and/or transition group III as catalyst.

In view of the high oxophilicity of, for example, trivalent boron compounds, it is highly surprising that the siloxane skeleton remains essentially intact in the process of the invention. An attack of, for example, Lewis-acid trivalent boron compounds on the Si—O—Si structural unit of the siloxane skeleton, as would be expected according to the prior art, would inevitably lead to a noticeable shortening of the chains, but this is not observed according to the invention. Likewise it would have been expected that the polyether alcohols and alcohols used would have been deoxygenated because of the pronounced oxophilicity of the boron compounds. This, too, surprisingly does not occur according to the invention.

Furthermore, it has surprisingly been found that the process of the invention allows polyorgano-hydrogensiloxanes of the formula (I) to be converted in the absence of solvents and without further processing steps to form both substituted polyorganosiloxanes which are known per se and new substituted polyorganosiloxanes. Dispensing with solvents and work-up steps is economically and ecologically advantageous. In the process of the invention, a final filtration serves merely to remove coarse solid particles from the otherwise clear reaction product and thus does not represent a work-up step in the sense of the prior art.

A further advantage of the process of the invention is that it is also possible to use polyorganosiloxanes which can still contain traces of acid resulting from the equilibration method using acid compounds, despite neutralization. Furthermore, the process of the invention also allows the use of siloxanes which have not been neutralized, which results in further advantages in terms of process simplification.

The presence of traces of acid in siloxanes, in contrast to silanes, which results from the equilibration method, leads, in the presence of Lewis-acid compounds such as trivalent boron compounds, to superacids. The superacids which are to be expected cause undesirable reequilibration of the siloxanes according to prior art. However, such reequilibrations are not observed in the process of the invention.

If should be emphasized that when unsaturated alcohols are used, no reaction of the Si(H) function with the double bond takes place. In this way, unsaturated Si—O—C-bonded reaction products can be prepared.

As effective catalysts for the purposes of the present invention, preference is given among the Lewis-acid compounds of elements of main group III to, in particular, boron-containing and/or aluminum-containing compounds. Among the Lewis-acid compounds of elements of transition group III, particular preference is given to scandium-containing, yttrium-containing, lanthanum-containing and/or lanthanide-containing Lewis acids. According to the invention, the compounds of elements of main group III and/or transition group III are particularly preferably used as halides, alkyl compounds, fluorine-containing, cycloaliphatic and/or heterocyclic compounds.

In a preferred embodiment of the invention, use is made of fluorinated and/or unfluorinated organoboron compounds, in particular compounds selected from among: (C₅F₄)(C₆F₅)₂B; (C₅F₄)₃B; (C₆F₅)BF₂; BF(C₆F₅)₂; B(C₆F₅)₃; BCl₂(C₆F₅); BCl(C₆F₅)₂; B(CrH₅)(C₆F₅)₂; B(Ph)₂(C₆F₅); [C₆H₄(mCF₃)]₃B; [C₆H₄(pOCF₃)]₃B; (C₆F₅)B(OH)₂; (C₆F₅)₂BOH; (C₆F₅)₂BH; (C₆F₅)BH₂; (C₇H₁₁)B(C₆F₅)₂; (C₈H₁₄B)(C₆F₅); (C₆F₅)₂B(OC₂H₅); (C₆F₅)₂B—CH₂CH₂Si(CH₃)₃;

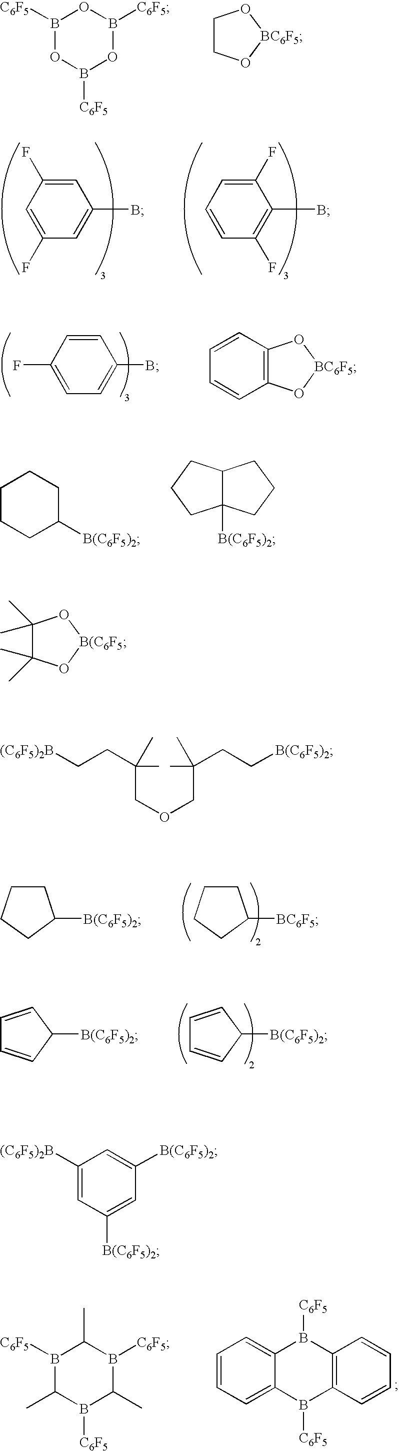

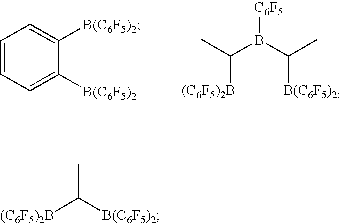

in particular tris(perfluorotriphenylborane) [1109-15-5], boron trifluoride etherate [109-63-7], the borane-triphenylphosphine complex [2049-55-0], triphenylborane [960-714], triethylborane [97-94-9] and boron trichloride [10294-34-5], tris(pentafluorophenyl)boroxin (9Cl) [223440-98-0], 4,4,5,5-tetramethyl-2-(pentafluorophenyl)-1,3,2-dioxaborolane (9Cl) [325142-81-2], 2-(pentafluorophenyl)-1,3,2-dioxaborolane (9C₁) [336880-934], bis(pentafluorophenyl)cyclohexylborane [245043-30-5], di-2,4-cyclopentadien-1-yl(pentafluorophenyl)borane (9Cl) [336881-03-9], (hexahydro-3a(1H)-pentalenyl)bis(pentafluorophenyl)borane (9Cl) [336880-98-9], 1,3-[2-[bis-(pentafluorophenyl)boryl]ethyl]tetramethyldisiloxane [336880-99-0], 2,4,6-tris(pentafluorophenyl)borazine (7Cl, 8Cl, 9Cl) [1110-39-0], 1,2-dihydro-2-(pentafluorophenyl)-1,2-azaborine (9Cl) [336880-94-5], 2-(pentafluorophenyl)-1,3,2-benzodioxaborole (9Cl) [336880-96-7], tris(4-trifluoromethoxyphenyl)borane [336880-95-6], tris(3-trifluoromethylphenyl)borane [24455-00-3], tris(4-fluorophenyl)borane [47196-74-7], tris(2,6-difluorophenyl)borane [146355-09-1], tris(3,5-difluorophenyl)borane [154735-09-8], methylium triphenyltetrakis(pentafluorophenyl)borate [136040-19-2], N,N-dimethylanilinium tetrakis(pentafluorophenyl)borate and mixtures of the abovementioned catalysts.

In a further preferred embodiment of the invention, use is made of fluorinated and/or unfluorinated organoaluminum compounds, in particular compounds selected from among: AlCl₃ [7446-70-0], aluminum acetylacetonate [13963-57-0], AlF₃ [7784-18-1], aluminum trifluoromethanesulfonate [74974-61-1], di-1-butylaluminum chloride [1779-25-5], di-1-butylaluminum hydride [1191-15-7], triethylaluminum [97-93-8] and mixtures thereof.

In a further preferred embodiment of the invention, use is made of fluorinated and/or unfluorinated organoscandium compounds, in particular compounds selected from among: scandium(III) chloride [10361-84-9], scandium(III) fluoride [13709-47-2], scandium(III) hexafluoroacetylacetonate [18990-42-6], scandium(III) trifluoromethanesulfon ate [144026-79-9], tris(cyclopentadienyl)scandium [1298-54-0] and mixtures thereof.

In a further preferred embodiment of the invention, use is made of fluorinated and/or unfluorinated organoyttrium compounds, in particular compounds selected from among: Tris(cyclopentadienyl)yttrium [1294-07-1], yttrium(III) chloride [10361-92-9], yttrium(III) fluoride [1370949-4], yttrium(III) hexafluoroacetylacetonate [18911-76-7], yttrium(III) naphthenate [61790-20-3] and mixtures thereof.

In a further preferred embodiment of the invention, use is made of fluorinated and/or unfluorinated organolanthanum compounds, in particular compounds selected from among: Lanthanum(III) chloride [10099-58-8], lanthanum(III) fluoride [13709-38-1], lanthanum(III) iodide [13813-224], lanthanum(III) trifluoromethanesulfonate [52093-26-2], tris(cyclopentadienyl)lanthanum [1272-23-7] and mixtures thereof.

In a further preferred embodiment of the invention, use is made of fluorinated and/or unfluorinated organolanthanide compounds, in particular compounds selected from among: Cerium(III) bromide [14457-87-5], cerium(III) chloride [7790-86-5], cerium(III) fluoride [7758-88-5], cerium(IV) fluoride [60627-09-0], cerium(III) trifluoroacetylacetonate [18078-37-0], tris(cyclopentadienyl)cerium [1298-53-9], europium(III) fluoride [13765-25-8], europium(II) chloride [13769-20-5], praesodymium(III) hexafluoroacetylacetonate [47814-20-0], praesodymium(III) fluoride [13709-46-1], praesodymium(III) trifluoroacetylacetonate [59991-56-9], samarium(III) chloride [10361-82-7], samarium(III) fluoride [13765-24-7], samarium(III) naphthenate [61790-20-3], samarium(III) trifluoroacetylacetonate [23301-82-8], ytterbium(III) fluoride [13760-80-8], ytterbium(III) trifluoromethanesulfonate [54761-04-5], tris(cyclopentadienyl)ytterbium [1295-20-1] and mixtures thereof.

The catalyst can be used as a homogeneous or heterogeneous catalyst. Homogenized heterogeneous catalysis or heterogenized homogeneous catalysis is likewise possible within the scope of the invention.

In the process of the invention, it is possible to use essentially any organic compound having alcoholic hydroxyl groups, including monoalcohols, diols, triols, polyols, amino alcohols, fluoroalcohols, or any other substituted alcohols, and, for example, hydroxycarboxylic acids and their respective derivatives. Particular preference is given to ethanol and polyether alcohols which have been functionalized by means of propylene oxide and/or ethylene oxide and started using, for example, butyl alcohol, allyl alcohol or nonylphenol and also polyether alcohols containing styrene oxide and/or butylene oxide. Particular preference is also given to amino alcohols. An advantage of these alkyls is that the process can be carried out particularly economically when using them.

The alcohol is preferably used in an equimolar amount or in excess; the molar ratio of SiH groups to alcohol groups is particularly preferably set to a value in the range from about 1:1.0 to about 1:3.0 in the process of the invention.

Partially substituted polyorganosiloxanes which contain unreacted Si(H) units in addition to the substituted Si—O—C units can also be prepared readily by the process of the invention. For this purpose, the molar ratio of SiH groups to alcohol groups is preferably set to a value in the range from about 1:0.1 to about 1:0.99.

Such a reaction in a substoichiometric ratio leaves residual unreacted Si—H functions which can be reacted in a subsequent step, for example in a hydrosilylation reaction to form silicon-carbon bonds, in order to produce mixed products. In a similar way, polyethersiloxanes having terminal OH functions can be added onto the siloxane skeleton via a dehydrogenative coupling reaction.

To suppress the secondary reaction of Si—H to form Si—OH, it is advantageous to dry the alcohols before use, especially when using polyether alcohols. This can be carried out by, for example, vacuum distillation. The dehydrogenative coupling reaction can also be favored by making the medium slightly acidic. To make the alcohol to be reacted slightly acidic, it is possible to add, for example, diammonium phosphate (DAP; 100 to 500 ppm) before, during or after the distillation.

In addition, it has been found that the process of the invention can be carried out equally well in neutral or alkaline media. For example, polyethers prepared in the presence of alkali could be used successfully in the process of the invention without being neutralized after their preparation.

Polyorganosiloxanes used in the process of the invention can be purely terminal, i.e. Si—H groups are present only at the ends of the polysiloxane chain, purely lateral, i.e. Si—H groups are present only in the interior of the molecule but not at the ends of the polysiloxane chain, or have a mixed structure.

In the same way and very particularly preferably, comb-like, α,ω-disubstituted and mixed polydimethylhydrogensiloxanes of the formula (I) can be used in the process of the invention.

Very particular preference is given, for example, to using polyorganosiloxanes of the formula (II):

M-O-Dₓ-D′_{y}-M (II)

where

M is trialkylsilyl, in particular trimethylsilyl,

D is (dialkylsilyloxy), in particular (diihethylsilyloxy),

D′ is

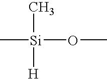

and

x and y are defined in formula (I).

Very particular preference is likewise given, for example, to the use of polyorganosiloxanes of the formula (III):

M′-O-Dₓ-M′ (III)

where

M′ is dialkyl(hydrogen)silyl, in particular dimethylhydrogensilyl, and

D is (dialkylsilyloxy), in particular (dimethylsilyloxy) and

x is defined in formula (I).

Very particular preference is likewise given, for example, to the use of polyorganosiloxanes of the formula (IV)

M′-O-Dₓ-D′_{y}-M′ (IV)

where

M′ is dialkyl(hydrogen)silyl, in particular dimethylhydrogensilyl,

D is (dialkylsilyloxy), in particular (dimethylsilyloxy)ₓ,

D′ is

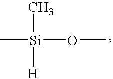

and

x and y are as defined in formula (I).

The process of the invention can be carried out without use of solvents, which represents a considerable advantage from an economic and ecological standpoint over the processes of the prior art, in particular for large-scale industrial implementation.

The present invention further provides polyorganosiloxanes obtainable by a process according to the invention.

In contrast to processes of the prior art, the process of the invention makes it possible to prepare polyorganosiloxanes which have been substituted by organooxy groups and/or aminoorganooxy groups and are not contaminated with hydrochloric acid or hydrogen chloride resulting from the substitution reaction or chlorides produced by their neutralization. This makes further processing or work-up considerably easier. For example, it is no longer necessary to filter off the chloride-containing neutralization product, for example in the form of ammonium chloride. Furthermore, not only are neutralization products in the abovementioned sense and the use of filter aids avoided, but product losses resulting from product adhering to the salt and possibly to the filter aid are eliminated.

The process of the invention therefore provides a way of preparing polyorganosiloxanes containing terminal and/or lateral Si—O—C-bonded uniform or mixed radicals selected from among linear or branched, saturated, monounsaturated or polyunsaturated, aromatic or aliphatic-aromatic monoalcohols and polyalcohols, polyethers, polyether alcohols and amino alcohols, in particular N-alkyl-, arylamino-EO-, —PO alcohols, N-alkyl and arylamino alcohols and mixtures thereof, which are free of the abovementioned impurities, in particular residues of hydrochloric acid and neutralization products containing chloride.

Particular preference is given to polyorganosiloxanes in which the radicals are selected from among simple alcohols such as methanol, ethanol, 1H-pentadecafluoro-1-1octanol, etc., and butyl polyethers, allyl polyethers, nonylphenol polyethers, methyl polyethers and amino polyethers.

In a further embodiment of the invention, the polyorganosiloxanes of the invention are preferably used for the treatment of textiles, as additives for plastics or in the building paints sector and/or as polyurethane foam stabilizers.

The following non-limiting examples illustrate the invention.

### EXAMPLES

General:

Siloxanes:

The siloxanes were generally purely terminal siloxanes (for example: M′-O-D₁₃-M′) or purely lateral siloxanes (for example: M-O-D′₅-D₂₂-M).

Alcohols:

The polyether alcohols were freed of residual traces of water by distillation under reduced pressure before use. Before the distillation, diammonium phosphate (DAP; 350 ppm) was optionally added.

Boron-Containing Catalyst:

The catalyst was used as commercially available, i.e. without further treatment and purification.

Method of Carrying Out the Reaction:

All reactions were carried out under protective gas. The reaction formed hydrogen which was discharged via a bubble counter. A distinction was made between three ways of carrying out the reaction.

Method (A):

The polyether/alcohol were placed in the reaction vessel, the mixture was heated to reaction temperature, the catalyst was added and the siloxane was subsequently added dropwise with regulation of the temperature.

Method (B):

The siloxane was placed in the reaction vessel and heated to reaction temperature, the catalyst was added and the polyether was subsequently added dropwise with regulation of the temperature.

Method (C):

The siloxane and polyether were placed in the reaction vessel, the mixture was heated to reaction temperature, the catalyst was added and the reaction was carried out.

Work-Up:

Unless indicated otherwise, the following standard work-up was employed:

The reaction mixture was prepared for filtration by addition of an amine. It was subsequently filtered through a depth-filter sheet, if appropriate under slightly superatmospheric pressure. The filtration was carried out using a depth-filter sheet as employed for solid/liquid separation in the field of clarifying or rough filtration. The main constituents of this filter bed were celluloses, natural diatomaceous earths and perlites. The filter bed used had a water flux of about 275 l/m² min (at 100 kPa), a mass per unit area of about 1240 g/m² and a thickness of about 3.7 mm.

Analyses:

The conversion was measured by determining the residual SiH functions by means of a gas-volumetric hydrogen determination [conversion reported in %; SiH value in eq/kg of test substance]. The iodine number, viz. consumption of iodine by reaction with a double bond, was employed to determine the number of double bonds present [iodine number reported in g of I₂/100 g of test substance]. The OH number was determined by reaction of phthalic anhydride with free hydroxy groups. The free acid was backtitrated with a solution of base [OH number reported in mg of KOH/g of test substance]. The viscosity was determined in a falling sphere viscometer.

Firstly reactions of terminal hydrogensiloxanes and then the reaction of a lateral siloxane are described below.

Reactions of terminal hydrogensiloxanes in a dehydrogenative hydrosilylation:

### Example 1

Reaction of M′-O-D₁₃-M′-siloxane with a butyl polyether Using tris(perfluorotriphenylborane):

104.4 g of M′-O-D₁₃-M′-siloxane (SiH value=1.82 eq/kg) were reacted with 400 g of a purely PO-containing polyether (mean molar mass=1900 g/mol) which had been started using butyl alcohol and had an OH number of 29.3. The polyether was used in an excess of 10% by mass, conditioned with 0.14 g of DAP and dried by distillation under reduced pressure. In accordance with method (C), 0.51 g of tris(perfluorotriphenylborane), corresponding to 0.5 mol % based on the SiH value, was added at 90° C. The reaction temperature rose briefly to 102° C. After 25 minutes, the conversion determined via the SiH value was 100%. 1 g of N-methylmorpholine was added prior to filtration through the depth-filter sheet.

The filtrate had an SiH value of 0 and a viscosity of 374 mm²*s⁻¹.

### Example 2

Reaction of M′-O-D₁₃-M′-siloxane with ethanol Using tris(perfluorotriphenylborane):

408 g of an unneutralized M′-O-D₁₃-M′-siloxane (SiH value=1.78 eq/kg) which had been equilibrated using phosphazene were reacted with 92 g of ethanol (100% pure). The ethanol was used in an excess of 178% by mass. In accordance with method (A), 0.59 g of tris-(perfluorotriphenylborane) (corresponding to 0.15 mol % based on the SiH value) was introduced and the siloxane was added dropwise at reflux temperature over a period of 2 hours. After the siloxane addition was complete, the conversion determined via the SiH value was 82%. Further boiling under reflux for another 1.5 hours gave a clear solution whose SiH value was 0, corresponding to a conversion of 100%.

All volatile constituents were removed at 100° C. under reduced pressure. After subsequent filtration, a clear product solution was obtained.

### Example 3

Reaction of M′-O-D₁₃-M′-siloxane with a butyl polyether Using a Mixture of tris(perfluorotriphenylborane) and triphenylborane:

80 g of M′-O-D₁₃-M′-siloxane (SiH value=1.77 eq/kg) were reacted with 300 g of a purely PO-containing polyether (mean molar mass=1900 g/mol) which had been started using butyl alcohol and had an OH number of 29.3. The polyether was used in an excess of 10% by mass, conditioned with 0.105 g of DAP and dried by distillation under reduced pressure. In accordance with method (A), a mixture (predissolved in the product from experiment 1) consisting of 0.076 g of tris(perfluorotriphenylborane) and 0.017 g of triphenylborane, corresponding to 0.157 mol % of boron based on the SiH value, was added at 90° C. The siloxane was added dropwise at 90° C. over a period of 30 minutes, during which time the reaction temperature rose to a maximum of 95° C. After the siloxane addition was complete, the conversion determined via the SiH value was 100%. 0.75 g of N-methylmorpholine was added prior to filtration through the depth-filter sheet.

The filtrate had an SiH value of 0 and a viscosity of 379 mm²*s⁻¹.

### Example 4

Reaction of M′-O-D₁₃-M′-siloxane with a butyl polyether Using a Mixture of tris(perfluorotriphenylborane) and boron trifluoride etherate:

80 g of M′-O-D₁₃-M′-siloxane (SiH value=1.77 eq/kg) were reacted with 300 g of a purely PO-containing polyether (mean molar mass=1900 g/mol) which had been started using butyl alcohol and had an OH number of 29.3. The polyether was used in an excess of 10% by mass, conditioned with 0.105 g of DAP and dried by distillation under reduced pressure. In accordance with method (A), a mixture. (predissolved in the product from experiment 1) consisting of 0.0534 g of tris(perfluorotriphenylborane) and 0.0073 g of boron trifluoride etherate, corresponding to 0.11 mol % of boron based on the SiH value, was added at 90° C. The siloxane was added dropwise at 90° C. over a period of 30 minutes, during which time the reaction temperature rose to a maximum of 95° C. After the siloxane addition was complete, the conversion determined via the SiH value was 100%. 0.75 g of N-methylmorpholine was added prior to filtration through the depth-filter sheet. The filtrate had an SiH value of 0 and a viscosity of 398 mm²*s⁻¹.

Reactions of lateral hydrogensiloxanes in a dehydrogenative hydrosilylation:

### Example 5

Reaction of M-O-D′₅-D₂₂-M-siloxane with an allyl polyether Using tris(perfluorotriphenylborane):

100 g of M-O-D′₅-D₂₂-M-siloxane (SiH value=2.54 eq/kg) were reacted with 276.1 g of a mixed EO-/PO-containing polyether (mean molar mass=600 g/mol; proportion of PO=26 mol %) which had been started using allyl alcohol and had an iodine number of 30.4. The polyether was used in an excess of 30% by mass. In accordance with method (C), 0.68 g of tris(perfluorotriphenylborane), corresponding to 0.5 mol % based on the SiH value, was added at 90° C. After 240 minutes, the conversion determined via the SiH value was 100%. The reaction product was filtered through the depth-filter sheet.

The filtrate had an SiH value of 0, an OH number of 26.7 (corresponding to the unreacted excess of polyether), an iodine number of 22.4 (theoretical iodine number=22.3 for complete reaction of all double bonds present) and a viscosity of 275 mPas.

### Example 6

Reaction of M′-O-D₁₃-M′-siloxane with a butyl polyether Using scandium(III) triflate:

80 g of M′-O-D₁₃-M′-siloxane (SiH value=1.77 eq/kg) were reacted with 300 g of a purely PO-containing polyether (mean molar mass=1900 g/mol) which had been started using butyl alcohol and had an OH number of 29.3. The polyether was used in an excess of 10% by mass. In accordance with method (A), 0.1 g of scandium(III) triflate, corresponding to 0.15 mol % of scandium based on the SiH value, was added at 90° C. The siloxane was added dropwise at 90° C. over a period of 30 minutes, during which time the reaction temperature rose to a maximum of 95° C. After the siloxane addition was complete, the conversion determined via the SiH value was 100%. 1 g of N-methylmorpholine was added prior to filtration through the depth-filter sheet.

### Example 7

Reaction of M′-O-D₁₃-M′-siloxane with a butyl polyether Using scandium(III) triflate and tris(perfluorotriphenylborane):

80 g of M′-O-D₁₃-M′-siloxane (SiH value=1.77 eq/kg) were reacted with 300 g of a purely PO-containing polyether (mean molar mass=1900 g/mol) which had been started using butyl alcohol and had an OH number of 29.3. The polyether was used in an excess of 10% by mass. In accordance with method (A), 0.05 g of scandium(III) triflate and 0.05 g of tris(perfluorotriphenylborane), corresponding to 0.075 mol % of scandium and 0.075 mol % of boron based on the SiH value, were added at 90° C. The siloxane was added dropwise at 90° C. over a period of 30 minutes, during which time the reaction temperature rose to a maximum of 95° C. After the siloxane addition was complete, the conversion determined via the SiH value was 100%. 1 g of N-methylmorpholine was added prior to filtration through the depth-filter sheet.

An overview of the examples carried out and general examples is given in the following table:

TABLE

| Hydrogen- | Polyether/ | | | Amount of | Reaction | |
|---|---|---|---|---|---|---|
| siloxane | alcohol | Method* | Catalyst* | catalyst | temperature | Time |
| M′-O-D₁₃-M′ | purely PO- | C and A | [1109-15-5] | 0.11-0.5 | 90-102° C. | 25 min to |
| | containing PE | | alone or in | mol % of | | 30 min |
| | started using | | admixture | boron based | | |
| | butyl alcohol | | with [109- | on SiH | | |
| | | | 63-7], [960- | | | |
| | | | 71-4] | | | |
| M′-O-D₁₃-M′ | purely PO- | A | [144026-79- | 0.15 mol % of | 90-95° C. | 30 min |
| | containing PE | | 9] | scandium | | |
| | started using | | | based on SiH | | |
| | butyl alcohol | | | | | |
| M′-O-D₁₃-M′ | purely PO- | A | [144026-79- | 0.075 mol % | 90-95° C. | 30 min |
| | containing PE | | 9] in | of scandium, | | |
| | started using | | admixture | 0.075 mol % | | |
| | butyl alcohol | | with [1109- | of boron, in | | |
| | | | 15-5] | each case | | |
| | | | | based on SiH | | |
| M′-O-D₁₃-M′ | ethanol | A | [1109-15-5] | 0.15 mol % | 70° C. | 210 min |
| | | | | of boron | | |
| | | | | based on | | |
| | | | | SiH | | |
| M-O-D′₅-D₂₂-M | mixed EO-/PO- | C | [1109-15-5] | 0.5 mol % | 60-130° C. | 240 min |
| | containing PE | | | of | | |
| | started using | | | boron | | |
| | allyl alcohol | | | based on | | |
| | | | | SiH | | |

General

| | | | | | | |
|---|---|---|---|---|---|---|
| M′-O-Dₓ-M′ | simple alcohol, | | compounds of | 0.005 mol % | | 10 min- |
| M-O-D′ₓ- | butyl-or allyl- | | elements of | 1 mol % of | | 300 min |
| D_{y}-M | initiated pure | | main group III | boron based | | |
| | or mixed EO/ | | and transition | on SiH | | |
| | PO polyether | | group 3 (for | | | |
| | | | details, see*) | | | |
| M′-O-D′ₓ- | | A, B or C | | | 60-130° C. | |
| D_{y}-M′ | | | | | | |

*see general part of experimental description

### Example 8

Conversion of Fluowet EA 600 (Firm: Clariant) with an Internally Located Si—H Functional polysiloxane (D=9.3, D′=8.7) Using a Catalyst Containing Boron.

72.8 g Fluowet EA 6000 were heated in a four-neck flask, fitted with a stirrer, intensive cooler, thermometer and addition funnel, together with 0.1024 g tris(pentafluorotriphenyl)boran as a catalyst and 21 g toluol in an inert atmosphere to 90° C. When the desired temperature was reached, 32.15 grams of laterally located Si—H-functionalized polysiloxane (D=9.3, D′=8.7) of the general formula Me₃SiO(SiMe₂O)_{9.3}(SiMeHO)_{8.7}SiMe₃(SiH-value:0.627%) are added dropwise within 15 mins. Following addition and cooling the conversion was at 100%, corresponding to the SIH-method. Following distilling off of the volatile compounds a clear, colorless liquid is obtained.

### Example 9

Conversion of Fluowet EA600 (Firm: Clan ant) with the terminally-located Si—H-functional polysiloxane (D8, M′=2) using a catalyst containing boron. 77.44 g Fluowet EA 600 are heated in a four-neck flask, fitted with stirrer, intensive cooler, thermometer and addition funnel, together with 0.108 g tris(pentafluorotriphenyl)boron as a catalyst and 30 g toluol in an inert atmosphere to 90° C. When the desired temperature is reached, 72.45 grams of centrally-located Si—H functionalized polysiloxane (D=8, M′=2) of the general formula HMe₂SiO(SiMe₂O)₈SiMe₂H(SiH-value:0.296%) are added dropwise within 15 minutes. Following addition and cooling the conversion was at 100%, corresponding to the S1H-method. After distilling off of the volatile compounds a colorless, slightly cloudy liquid is obtained.

The above description of the invention is intended to be illustrative and not limiting. Various changes or modifications in the embodiments described herein may occur to those skilled in the art. These changes can be made without departing from the scope of the spirit of the invention.

1. A process for preparing alkoxy-substituted polyorganosiloxane comprising reacting at least one polyorganosiloxane of the formula 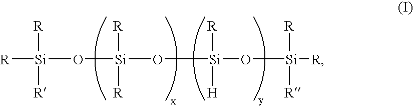
in which at least one hydrogen atom is bound to a silicon atom;
R represents one or more identical or different radicals which are linear or branched, saturated, monounsaturated or polyunsaturated alkyl, aryl, alkaryl and aralkyl radicals optionally substituted with haloalkyl groups, siloxy groups and/or triorganosiloxy groups;
R′ and R″ are each, independently of one another, H or R;
x is an integer from 0 to 300 and
y is, independently of x, an integer from 0 to 100;
with at least one alcohol which is linear or branched, saturated, monounsaturated or polyunsaturated, aromatic or aliphatic-aromatic monoalcohol or polyalcohol, a polyether monoalcohol, a polyether polyalcohol, or aminoalcohol, in the presence of a main group III and/or transition group III catalyst and, optionally, a solvent.

2. The process according to claim 1 wherein R represents one or more identical or different radicals which are linear or branched, saturated, monounsaturated or polyunsaturated alkyl, aryl, alkaryl or aralkyl radicals having from 1 to 20, carbon atoms each optionally substituted with haloalkyl groups having from 1 to 20 carbon atoms, siloxy groups and/or triorganosiloxy groups;

3. The process according to claim 2 wherein R represents one or more identical or different radicals which are linear or branched, saturated, monounsaturated or polyunsaturated alkyl, aryl, alkaryl or aralkyl radicals having from 1 to 10 carbon atoms, each optionally substituted by haloalkyl groups having from 1 to 20 carbon atoms, siloxy groups and/or triorganosiloxy groups and the alcohols are a N-alkyl alcohol, an arylamino-EO-alcohol, an arylamino alcohol or a mixture of the foregoing.

4. The process according to claim 1 wherein the catalyst is an aluminum-containing catalyst, a scandium containing catalyst, a yttrium-containing catalyst, a lanthanum-containing catalyst, a lanthamide-containing catalyst or a mixture of any of the foregoing.

5. The process according to claim 4 wherein the ligands on the catalyst are halides, alkyl groups, fluorine-containing groups, a cycloaliphatic group or a heterocyclic group.

6. The process according to claim 5, wherein the catalyst used is selected from the group consisting of: (C₅F₄)(C₆F₅)₂B; (C₅F₄)₃B; (C₆F₅)BF₂; BF(C₆Fs)₂; B(C₆F₅)₃; BCl₂(C₆F₅); BCl(C₆F₅)₂; B(C₆H₅)(C₆F₅)₂; B(Ph)₂(C₆F₅); [C₆H₄(mCF₃)]₃B; [C₆H₄(pOCF₃)]₃B; (C₆F₅)B(OH)₂; (C₆F₅)₂BOH; (C₆F₅)₂BH; (C₆F₅)BH₂; (C₇H₁₁)B(C₆F₅)₂; (C₈H₁₄B)(C₆F₅); (C₆F₅)₂B(OC₂H₅); (C₆F₅)₂B-CH₂CH₂Si(CH₃)₃; 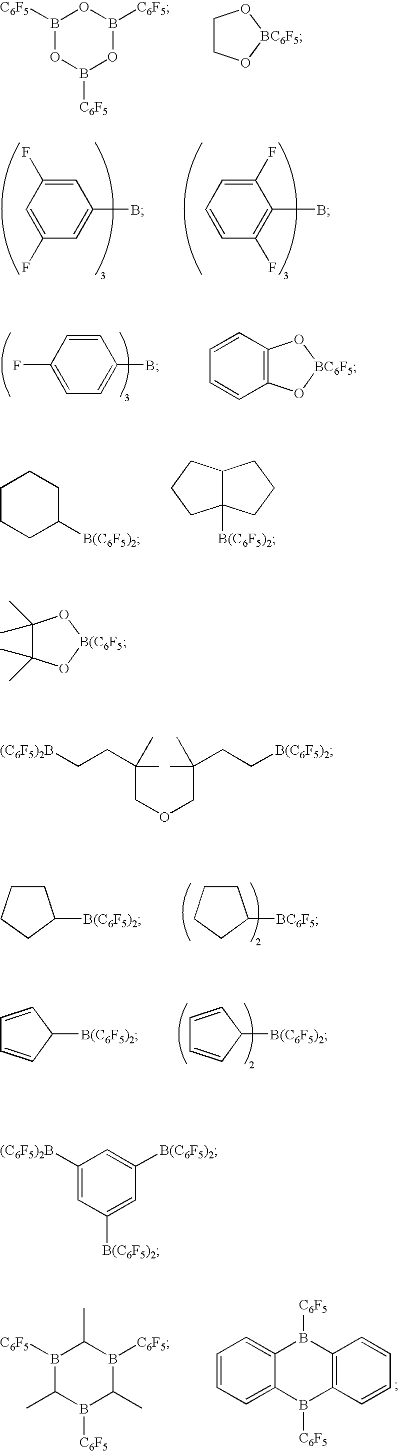 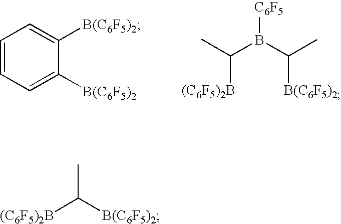
and a mixture thereof.

7. The process according to claim 4, wherein, the catalyst is selected from the group consisting of tris(perfluorotriphenylborane), boron trifluoride etherate, the borane-triphenylphosphine complex, triphenylborane, triethylborane and boron trichloride, tris(pentafluorophenyl)boroxin (9Cl), 4,4,5,5-tetramethyl-2-(pentafluorophenyl)-1,3,2-dioxaborolane (9Cl), 2-(pentafluorophenyl)-1,3,2-dioxaborolane (9Cl), bis(pentafluorophenyl)cyclohexylborane, di-2,4-cyclopentadien-1-yl(pentafluorophenyl)borane (9Cl), (hexahydro-3a(1H)-pentalenyl)bis(pentafluorophenyl)borane (9Cl), 1,3-[2-[bis(pentafluorophenyl)boryl]ethyl]tetramethyldisiloxane, 2,4,6-tris(pentafluorophenyl)borazine (7Cl, 8Cl, 9Cl), 1,2-dihydro-2-(pentafluorophenyl)-1,2-azaborine (9Cl), 2-(pentafluorophenyl)-1,3,2-benzodioxaborole (9Cl), tris(4-trifluoromethoxyphenyl)borane, tris(3-trifluoromethylphenyl)borane, tris(4-fluorophenyl)borane, tris(2,6-difluorophenyl)borane, tris(3,5-difluorophenyl)borane, methylium triphenyltetrakis(pentafluorophenyl)borate, N,N-dimethylanilinium tetrakis(pentafluorophenyl)borate and mixtures thereof.

8. The process according to claim 4, wherein the catalyst is selected from the group consisting of AlCl₃, aluminum acetylacetonate, AlF₃, aluminum trifluoromethanesulfonate, di-1-butylaluminum chloride, di-1-butylaluminum hydride, triethylaluminum and mixtures thereof.

9. The process according to claim 4, wherein the catalyst used is selected from the group consisting of: scandium(III) chloride, scandium(III) fluoride, scandium(III) hexafluoroacetylacetonate, scandium(III) trifluoromethanesulfonate, tris-(cyclopentadienyl)scandium and mixtures thereof.

10. The process according to claim 4, wherein the catalyst used is selected from the group consisting of: tris(cyclopentadienyl)yttrium, yttrium(III) chloride, yttrium(III) fluoride, yttrium(III) hexafluoroacetylacetonate, yttrium(III) naphthenate and mixtures thereof.

11. The process according to claim 4, wherein the catalyst used is selected from the group consisting of: lanthanum(III) chloride, lanthanum(III) fluoride, lanthanum(III) iodide, lanthanum(III) trifluoromethanesulfonate, tris(cyclopentadienyl)lanthanum and mixtures thereof.

12. The process according to claim 4, wherein the catalyst used is selected from the group consisting of: cerium(III) bromide, cerium(III) chloride, cerium(III) fluoride, cerium(IV) fluoride, cerium(III) trifluoroacetylacetonate, tris(cyclopentadienyl)cerium, europium(III) fluoride, europium(II) chloride, praesodymium(III) hexafluoroacetylacetonate, praesodymium(III) fluoride, praesodymium(III) trifluoroacetylacetonate, samarium(III) chloride, samarium(III) fluoride, samarium(III) naphthenate, samarium(III) trifluoroacetylacetonate, ytterbium(III) fluoride, ytterbium(III) trifluoromethanesulfonate, tris(cyclopentadienyl)ytterbium and mixtures thereof.

13. The process according to claim 1, wherein the alcohol used is selected from the group consisting of: methanol, ethanol, fluoroalcohol, butyl polyether alcohols, allyl polyether alcohols, nonylphenol polyether alcohols, polyether alcohols containing ethylene oxide and/or propylene oxide and/or styrene oxide and/or butylene oxide, amino alcohols and mixtures thereof.

14. The process according to claim 1, wherein the molar ratio of SiH groups to alcohol groups ranges from about 1:1.0 to about 1:3.0.

15. The process according to claim 1, wherein the molar ratio of SiH groups to alcohol groups ranges from about 1:0.1 to about 1:0.99.

16. The process according to claim 1, wherein the polyorganosiloxane is terminal polyoryamosiloxane, a lateral polyorganosiloxane or mixed-structure polyorganosiloxanes.

17. The process according to claim 1, wherein the polyorganosiloxane of formula (1) is comb-like, α,ω-disubstituted or a mixed polydimethylhydrogensiloxane (I).

18. The process as claimed in claim 17, wherein the polyorganosiloxanes are selected from the group consisting of compounds of the formula (II):
M-O-Dₓ-D′_{y}-M (II)
where
M is trialkylsilyl,
D is (dialkylsilyloxy),
D′ is 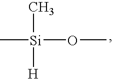
x is an interger from 0 to 300, and
y is, independently of x an interger from 0 to 100.

19. The process according to claim 18, wherein M is trimethylsilyl and d is dimethlysiloxy.

20. The process as claimed in claim 12, wherein the polyorganosiloxanes are selected from the group consisting of compounds of the formula (III):
M′-O-Dₓ-M′ (III)
where
M′ is dialkyl(hydrogen)silyl, and
D is (dialkylsilyloxy), and
X is an interger from 0 to 300.

21. The process according to claim 20, wherein M is dimethylhydrogensilyl and d is dimethylsiloxy.

22. The process as claimed in claim 12, wherein the polyorganosiloxanes used are selected from the group consisting of compounds of the formula (IV):
M′-O-Dₓ-D′_{y}M′ (IV)
where
M′ is dialkyl(hydrogen)silyl,
D is (dialkylsilyloxy)
D′is 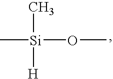
x is an interger from 0 to 300 and
y is, independently of x, an interger from 0 to 100.

23. The process according to claim 22 wherein M is dimethylhydrogensilyl and d is dimethylsiloxy.

24. The process according to claims wherein the reaction is carried out in the absence of solvents.

25. An alkoxy-substituted polyorganosiloxane obtainable by a process as claimed in claim 1.

26. A paint, polyurethane, foam stabilizer or plastic which comprise an alkoxy-substituted polyorganosiloxane according to claim 25.

27. A treatment agent for a textile which comprises an alkoxy-substituted olyorganosiloxane.
